(19) United States
(12) Patent Application Publication
(10) Pub. No.: US 2004/0239583 A1
(43) Pub. Date: Dec. 2, 2004

(54) Display unit for a vehicle

(76) Inventors: Richard Shelton, Coventry (GB); Howard Betts, Congleton (GB); Gary Ford, Warwickshire (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/816,441

(22) Filed: Apr. 1, 2004

(30) Foreign Application Priority Data
Mar. 31, 2003 (GB) 0307371.5

(51) Int. Cl. G09G 5/00

(52) U.S. Cl. 345/7

(57) ABSTRACT

A display unit for presenting visual information to the driver of a vehicle comprises a liquid crystal display 1, mirror 2 and prism 4 for presenting the driver with a magnified virtual image for viewing through a prism face 4c, the image appearing at a comfortable distance, beyond the vehicles windscreen. The elements 1, 2, 4 comprising the unit may. be supported in a framework 10 as a compact package and mounted in the vehicle's dashboard. The prism 4 may be lowered to a stored position when the display is not in use.

### BACKGROUND OF THE INVENTION

The present invention relates to display units for vehicles and particularly to display units for providing visual information to the driver of a motor vehicle.

### TECHNICAL FIELD OF THE INVENTION

GB-A-2246900 discloses a dashboard-mounted vehicle display unit comprising a liquid crystal display abutting one face of a prism wherein a real image produced by the liquid crystal display is reflected from a second face of the prism (which is positioned up against the vehicle's windscreen) and through its third face towards the driver's eye. The driver views the virtual image as if it were located on the windscreen. The problem with this arrangement is that in order to view this display, the driver must adjust the focal point of his eyes when he changes from looking at the road ahead to glancing at the display in front of him. This can result in accommodation eye strain and is particularly a problem for older drivers and for young drivers when travelling at night. The distance of the virtual image from the driver's eyes can be, in theory, increased by increasing the focussing power of the prism. However in order to obtain a comfortable distance (of at least 2 metres), such an increase in focussing power incurs the disadvantages of excessive optical aberrations and manufacturing difficulties.

### SUMMARY OF THE INVENTION

The present invention comprises a display unit for a vehicle, the display unit including; image display means for producing an image, and an optical system for permitting viewing of the image by a driver of the vehicle at a comfortable distance, wherein the optical system includes a reflecting surface and an optical prism having focusing power, the reflecting surface being interposed between the image display means and a first transmitting face of the optical prism and inclined with respect thereto to reflect the image onto said first face, whereupon the image is reflected from a second reflecting face of the optical prism towards and through a third transmitting face of the optical prism for viewing by the driver.

Hence the invention is configured to generate an initial real image whose content the driver will eventually observe, to form a virtual image of a desired size and position, and to provide a viewpoint through which the virtual image can be observed.

The provision of the reflecting surface permits an increase in the path length from the real image to the prism (which acts as a convex lens) without taking up a large amount of space in the dashboard (which might be required for other purposes), and thereby enabling the virtual image as viewed by the driver, to appear to be at a comfortable distance, without requiring a large curvature to be incorporated in the prism faces.

The image display means may, for example, be a liquid crystal display panel and light source. Alternatively, the image display means may comprise a plasma panel, ferromagnetic display or any other display device that will produce a suitable image.

The image may comprise vehicle information such as speed, engine temperature, etc in the form of alpha numeric data and graphical symbology. Alternatively or additionally, the image may comprise a view of the road ahead derived from signals from a forward-looking vehicle-mounted camera or infra red sensor.

The reflecting surface may comprise a silvered mirror and the prism may be made from glass or acrylic material or any other suitable optical material.

In one arrangement, the refractive index of the prism is chosen so that total internal reflection of the light rays comprising the image reflected through the first face occurs at the second face. Alternatively or additionally, the second face may be provided with a reflective coating.

In one embodiment, the distance from the display to the first face of the prism is set and the focussing power of the prism is arranged, (by setting the curvature of each of its three faces), so that the image viewed by the driver appears to be at a distance of approximately 1½ metres (from the driver's eye) between the windscreen and the front end of the vehicle. This has the advantage of ease of eye accommodation for the driver.

In a preferred embodiment, the image display means and reflecting surface are mounted within the dashboard of the vehicle, and the prism sits on top of it when in use. The prism may be moveable from a stored position within the dashboard to a deployed position on top of the dashboard by pivoting and/or sliding means. Some small adjustment may also be provided so that an optimum viewing angle can be provided to the driver.

Alternatively, the display unit may be incorporated in the instrument cluster.

### BRIEF DESCRIPTION OF THE DRAWINGS

Some embodiments of the invention will now be described, by way of example only, with reference to the drawings, of which FIG. 1 is a schematic diagram of a display unit in accordance with a first embodiment and incorporated in a vehicle,

FIG. 2 is a 3-D view of the display unit of FIG. 1,

and FIG. 3 is a schematic diagram illustrating deployment of a display unit in accordance with an alternative embodiment of the invention.

### DETAILED DESCRIPTION OF THE PREFERRED EMBODIMENTS

In FIG. 1, a display unit consists of a back-lit liquid crystal display panel 1 and a light-path-folding plane, silvered mirror 2 both mounted in a dashboard 3 of a vehicle, and a prism 4 mounted on the dashboard 3 and above a steering wheel 5. The position of a driver's eye is denoted by reference numeral 6 and a line of vision 7 extends from point 6 through the prism 4 and through and beyond the vehicle's windscreen 8.

The display panel 1 is conventional and is arranged in this example, to display icons, warning messages, vehicle speed and the like during day-time use and an image comprising a scene of the road ahead supplied by a vehicle-mounted forward-looking sensor (e.g. infra-red or night vision device, not shown) during night-time use.

An optical ray can be traced from the display panel 1 to the mirror 2 where it is reflected towards the prism 4. The ray passes through a first prism face 4a (which is convex) and is totally-internally reflected off a second face 4b which is plane. The ray then emerges through a third prism face 4c which is convex, towards the driver's eye at point 6. The driver, looking through the third face 4c of the prism, sees a magnified virtual image 9 at a distance of 2 metres or so. The geometrical relationships of the prism, mirror and display shown in the drawing, permit ease of packaging within the dashboard.

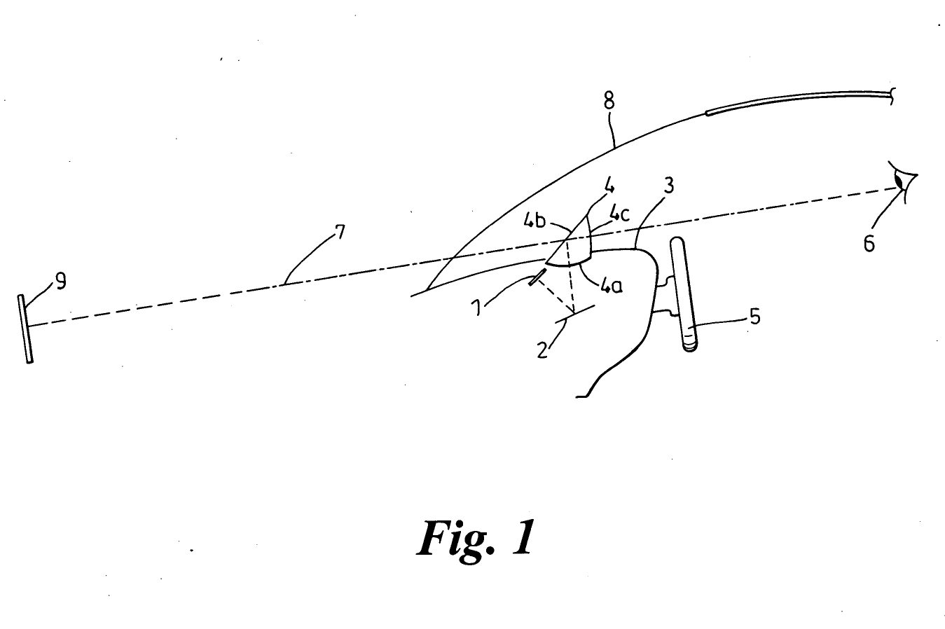

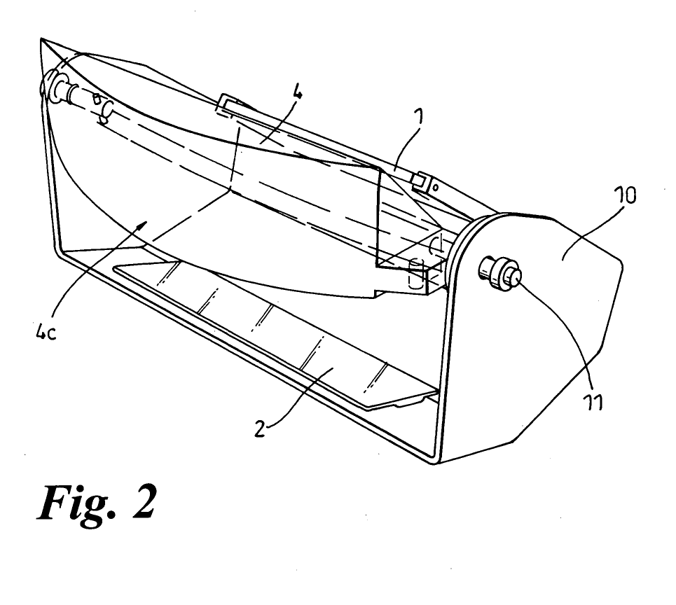

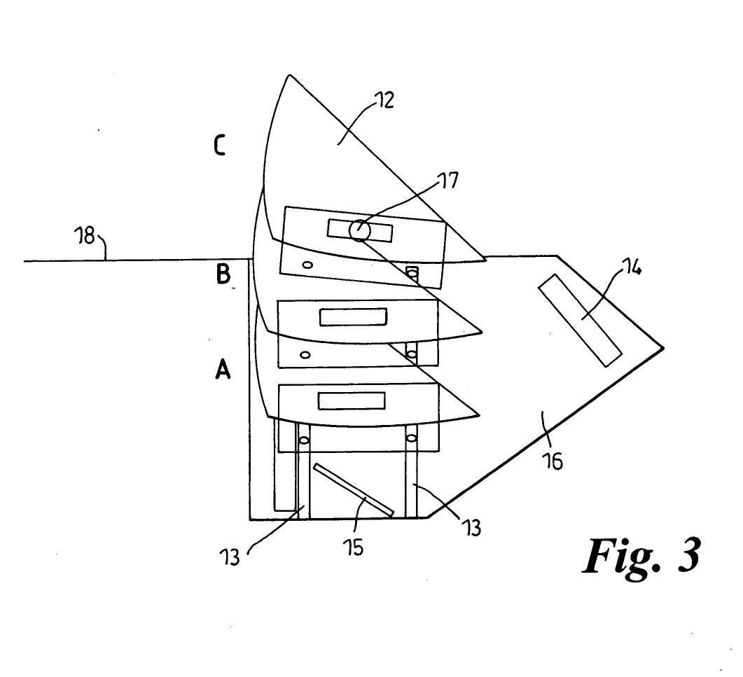

Referring to FIG. 2, the prism 4, mirror 2 and display panel 1 are all supported in a framework 10. The prism 4 is additionally provided with a pivotal attachment 11, which permits the driver to adjust the prism angle (relative to his position when seated) so as to optimise his viewing angle through the prism's faces 4c and 4b. This fine adjustment ensures that the driver can see the whole of the image presented by the display panel 1. The prism can also be rotated into a lowered stored position when not in use by virtue of the pivotal attachment 11.

FIG. 3. illustrates deployment of a prism 12 from a stored (lower) position in the dashboard of a vehicle to two deployed (upper) positions, partly above and fully above the dashboard. The prism is arranged to be supported in and slideable within guide channels 13. A LCD panel 14 and a mirror 15 are fixed within a support structure 16. The prism is also provided with a pivotal connection 17 to the framework 16, and the guide channels form a part of the framework 16.

In the stowed position A, the prism 12 is located beneath the upper surface 18 of the dashboard and out of sight.

In order to deploy the prism 12 for day-time use, the prism is driven upwards in the guide channels 13 by an electric motor (not shown) until half of its front face 12a protrudes above the dashboard's upper surface 18 (position B). The pivotal connection 17 is then adjusted by electrical motor means (not shown) so that the correct angular relationship between the prism and mirror is achieved. A fine adjustment can also be made by the driver to optimise viewing of the image appearing on the display panel 14. The display panel 14 now displays icons, warning messages and the like that the driver can see through upper half of the prism's front face 12a, at a comfortable viewing distance beyond the vehicle's windscreen. In this partly-deployed position, the area of windscreen that is obscured by the prism is kept to a minimum.

In order to attain the fully deployed position, C, the prism 12 is driven further upwards on the guide channels 13 until it fully extends beyond the dashboard's upper surface 18 and the pivotal connection 17 is adjusted appropriately. This position is used for night-time driving and the display panel 14 is adapted to show a scene of the road ahead supplied by a forward-looking infra-red camera (not shown). The driver now views this image through the whole of the front face 12a of the prism and at a comfortable viewing distance beyond the vehicle's windscreen.

In a further embodiment, the mirror 15 is mounted on a central pivot so that it can be repositioned from a stowed configuration to a deployed configuration having the correct angular position with respect to the display panel 14.

The display unit of the invention provides a rigid and stable optical arrangement with just three close-coupled, mechanically simple components.

Advantageously, the image is displayed to the driver in an ergonomically desirable way. It permits the image to appear very close to the driver's usual line of sight with sufficient brightness and resolution and at a distance which does not place excessive demands on the driver's eye accommodation and other capabilities.

I claim;

1. A display unit for a vehicle, the display unit including; image display means for producing an image, and an optical system for permitting viewing of the image by a driver of the vehicle at a comfortable distance, wherein the optical system includes a reflecting surface and an optical prism having focusing power, the reflecting surface being interposed between the image display means and a first transmitting face of the optical prism and inclined with respect thereto to reflect the image onto said first face, whereupon the image is reflected from a second reflecting face of the optical prism towards and through a third transmitting face of the optical prism for viewing by the driver.

2. A display unit according to claim 1 in which the image display comprises a liquid crystal display panel and a light source.

3. A display unit according to claim 1 in which the reflecting surface is a silvered mirror.

4. A display unit according to claim 1 in which the optical prism is made from glass.

5. A display unit according to claim 1 in which the optical prism is made from acrylic material.

6. A display unit according to claim 1 in which the second face of the optical prism is provided with a reflective coating.

7. A display unit according to claim 1 in which the first and third faces of the optical prism are convex and the second face is plane.

8. A display unit according to claim 1 in which the distance from the image display to the optical prism and the focussing power of the optical prism is arranged, so that the image viewed by the driver appears to be at a distance beyond the vehicle's windscreen and at a comfortable viewing distance from the driver's eye.

9. A display unit according to claim 1 in which the optical prism is adapted to be moveable between a stored position and a deployed position.

10. A display unit according to claim 9 in which the optical prism is adapted to be moveable between a stored position and a first deployed position where only an upper portion of the prism is visible to the driver.

11. A display unit according to claim 9 in which the optical prism is adapted to be moveable between a stored position and a second deployed position where substantially the whole of the prism is visible to the driver.

12. A display unit according to claim 9 and further incorporating a framework for supporting the optical prism wherein the optical prism is moveable between stowed and deployed positions within guide channels incorporated in said framework.

13. A display unit according to claim 1 in which the optical prism is adapted to be adjustable in order to provide an optimum viewing angle for the driver of the vehicle.

14. A display unit according to claim 12 wherein a pivotal connection is provided between the optical prism and the supporting framework.

15. A display unit according to claim 13 wherein a pivotal connection is provided between the optical prism and a supporting framework.
